(19) United States
(12) Patent Application Publication
(10) Pub. No.: US 2016/0035006 A1
(43) Pub. Date: Feb. 4, 2016

(54) STREAMLINED ONLINE CHECKOUT

(71) Applicant: PAYPAL, INC., San Jose, CA (US)

(72) Inventors: Richard Ray Ragan, Mountain View, CA (US); Michael Charles Todasco, Santa Clara, CA (US)

(21) Appl. No.: 14/882,333

(22) Filed: Oct. 13, 2015

Related U.S. Application Data
(63) Continuation of application No. 14/276,963, filed on May 13, 2014.

(51) Int. Cl. G06Q 30/06; G06Q 20/32

(52) U.S. Cl. CPC G06Q 30/0633; G06Q 20/3224; G06Q 20/327

(57) ABSTRACT

Methods and systems for facilitating online checkout with a beacon are described. A user may be automatically logged into a service provider site without inputting a user name, password, or other identifying information. A user's information may be automatically transmitted during checkout so that the user is not required to provide user name, password, billing information, or shipping address information.

### CROSS-REFERENCE TO RELATED APPLICATION

This application is a continuation of Ser. No. 14/276,963, filed May 13, 2014, all of which is incorporated herein by reference in its entirety.

### BACKGROUND

1. Field of the Invention

The present invention generally relates to facilitating user login and checkout in electronic commerce.

2. Related Art

Online or electronic commerce has become a large part of the global economy. Consumers are now able to purchase items through a merchant website. After a consumer selects items for purchase on the website, he or she clicks the checkout button. The consumer is then presented with another page, which typically includes a request for login credentials (i.e., user name, email address, and/or password). Once the consumer enters these details, he or she must also provide billing and shipping address information. Entering all this information can be cumbersome and frustrating for the consumer. Thus, a need exists for systems and methods that facilitate easier online login and checkout.

### BRIEF DESCRIPTION OF THE FIGURES

FIG. 1 is a block diagram illustrating a system for facilitating online checkout according to an embodiment of the present disclosure;

FIG. 2 is a flowchart showing a method for facilitating online checkout according to an embodiment of the present disclosure;

FIG. 3 is a flowchart showing a method for facilitating online checkout according to another embodiment of the present disclosure; and

FIG. 4 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods that remove the friction associated with purchasing items online. In various embodiments, a user is automatically logged in to a service provider site, without inputting a user name, password, or other identifying information. In other embodiments, a user's information is automatically transmitted during checkout so that the user is not required to provide user name, password, billing information, or shipping information.

In one embodiment, user information such as payment information (e.g., funding sources, billing address, etc.), shipping address, and authentication information (e.g., user ID, password, PIN, etc.) is stored in a beacon and is communicated to a user device in a secure location and in a secure way. When a user decides to make a purchase and proceeds to checkout, the beacon interacts with the user device and transmits the user information to the user device. The user device receives the information, and payment for the purchase is processed, without the user having to enter payment and/or authentication information.

In another embodiment, a user makes a purchase and proceeds to checkout on a first user device. The first user device is equipped with a beacon that transmits a message to a second user device. The message includes a request to pay using a service provider. A user accepts the request on the second user device, and the second user device automatically passes credentials (e.g., login or account credentials) to the first user device. The payment for the purchase is then processed.

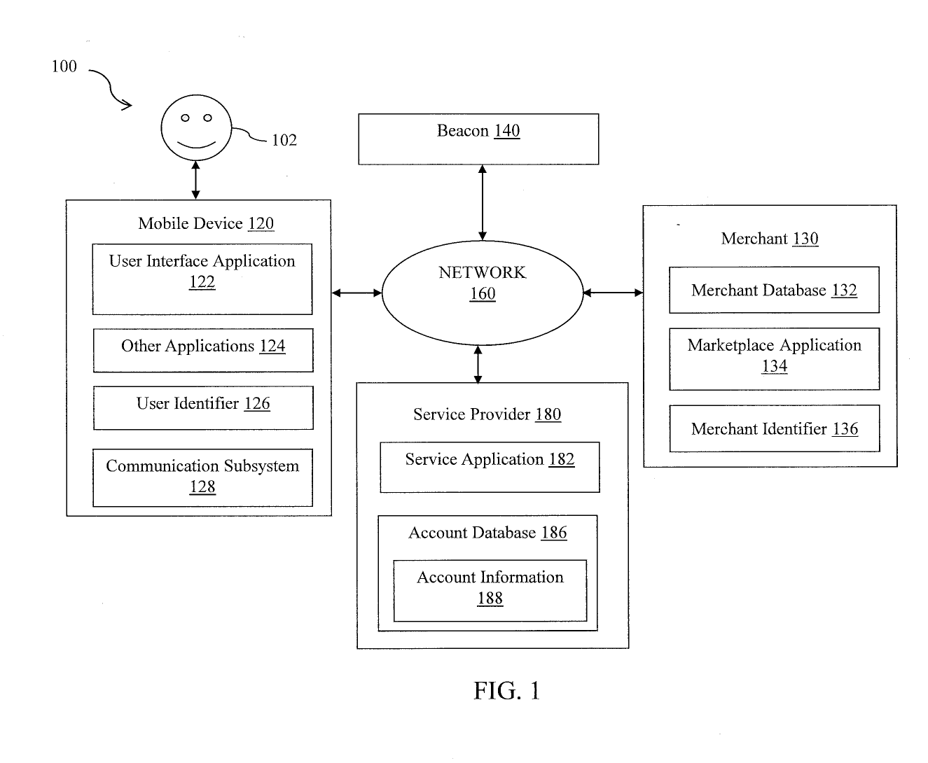

FIG. 1 shows one embodiment of a block diagram of a network-based system 100 adapted to facilitate checkout using a mobile device 120 over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a mobile device 120 (e.g., a smartphone), a merchant server or device 130, a beacon 140 (e.g., a radio frequency beacon or Bluetooth Low Energy (BLE) beacon), and at least one service provider server or device 180 (e.g., network server device) in communication over the network 160. The network 160, in one embodiment, may each be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The mobile device 120 is configured to perform one or more tasks when mobile device 120 is located in proximity to the beacon 140. The task to be performed can include, for example, launching an application program, setting certain files to non-accessible mode, initiating a phone call, sounding an alarm, storing a message, displaying a message, receiving a message, etc.

The mobile device 120, in various embodiments, may be implemented using any appropriate combination of hardware and/or software configured for wired and/or wireless communication over the network 160. The mobile device 120, in one embodiment, may be utilized by the user 102 to interact with the service provider server 180 over the network 160. For example, the user 102 may conduct financial transactions (e.g., account transfers, bill payment, etc.) with the service provider server 180 via the mobile device 120. In various implementations, the mobile device 120 may include a wireless telephone (e.g., cellular or mobile phone), a tablet, a wearable computing device, a personal computer, a notebook computer, and/or various other generally known types of wired and/or wireless computing devices.

The mobile device 120, in one embodiment, includes a user interface application 122, which may be utilized by the user 102 to conduct transactions (e.g., shopping, purchasing, bidding, etc.) with the merchant server or device 130 or the service provider server 180 over the network 160. In one aspect, purchase expenses may be directly and/or automatically debited from an account related to the user 102 by the service provider when the user 102 uses the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

In an example, the user 102 is able to access merchant websites via the one or more merchant servers 130 to view and select items for purchase, and the user 102 is able to purchase items from the one or more merchant servers 130 via the service provider server 180. Accordingly, in one or more embodiments, the user 102 may conduct transactions (e.g., purchase and provide payment for one or more items) from the one or more merchant servers 130 via the service provider server 180.

The mobile device 120, in various embodiments, may include other applications 124 as may be desired in one or more embodiments of the present disclosure to provide additional features available to user 102. In one example, such other applications 124 may include security applications for implementing client-side security features, calendar application, contacts application, location-based services application, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

The mobile device 120, in one embodiment, may include at least one user identifier 126, which may be implemented, for example, as operating system registry entries, cookies associated with the user interface application 122, identifiers associated with hardware of the mobile device 120, or various other appropriate identifiers. The user identifier 126 may include one or more attributes related to the user 102, such as personal information related to the user 102 (e.g., one or more user names, passwords, PIN numbers, photograph images, biometric IDs, addresses, phone numbers, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

In some embodiments, the mobile device 120 includes a communication subsystem 128, which can include radio frequency receivers and transmitters and/or optical (e.g., infrared) receivers and transmitters. The specific design and implementation of the communication subsystem 128 can depend on the communication network over which the mobile device 120 is intended to operate. For example, the mobile device 120 can include communication subsystems designed to operate over a Global System for Mobile Communication (GSM) network, a General Packet Radio Service (GPRS) network, an Enhanced Data Rates for Global Evolution (EDGE) network, a Wi-Fi or WiMax network, an LTE Direct network, and a Bluetooth™ network.

The one or more merchant servers 130, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering items to the user 102 over the network 160. As such, each of the one or more merchant servers 130 may include a merchant database 132 for identifying items for sale, which may be made available to the mobile device 120 for viewing and purchase by the user 102. In one or more embodiments, user 102 may complete a transaction such as purchasing the items via the service provider server 180.

Each of the merchant servers 130, in one embodiment, may include a marketplace application 134, which may be configured to provide information over the network 160 to the user interface application 122 of the mobile device 120. For example, user 102 may interact with the marketplace application 134 through the user interface application 122 over the network 160 to search and view various items available for purchase in the merchant database 132.

Each of the merchant servers 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. In various embodiments, user 102 may conduct transactions (e.g., searching, selection, monitoring, purchasing, and/or providing payment for items) with each merchant server 130. The service provider server 180 can assist in providing payment for items over the network 160.

A merchant website may also communicate (for example, using merchant server 130) with the service provider through service provider server 180 over network 160. For example, the merchant website may communicate with the service provider in the course of various services offered by the service provider to merchant website, such as payment intermediary between customers of the merchant website and the merchant website itself. For example, the merchant website may use an application programming interface (API) that allows it to offer sale of goods in which customers are allowed to make payment through the service provider, while user 102 may have an account with the service provider that allows user 102 to use the service provider for making payments to merchants that allow use of authentication, authorization, and payment services of service provider as a payment intermediary. The merchant website may also have an account with the service provider.

Beacon 140 may be a hardware device including sensors that is separate from a user device and transportable, or it can be a user device that includes Bluetooth technology. To prevent theft of beacons in cases where the beacon 140 is transportable, the beacon 140 may be “locked down” such that it would not function if moved to another location without secure configuration changes. Beacon 140 may be set up by merchants or individuals offering various items, such as products and/or services for sale. As defined herein, a “beacon” is a short range communication device having a known or fixed location that provides a signal that can be detected by mobile devices within a certain proximity of the beacon. An example of a beacon is a radio frequency (RF) beacon (e.g., Bluetooth™ low energy (BLE) beacon), infrared beacon or a radio frequency identifier (RFID) tag. For example, a BLE beacon can broadcast an RF signal that includes its position coordinates (e.g., latitude, longitude), which can be detected by a mobile device. In some implementations, the beacon can also advertise location based services provided by a beacon network. A beacon network encompasses a plurality of beacons in a geographic region.

Beacon 140 is typically maintained by one or more service providers. When user 102 comes in range of beacon 140, a mobile application on the mobile device 120 run by a service provider can wake up and connect to the beacon 140. Mobile device 120 can then receive messages from beacon 140, and beacon 140 can receive messages from the mobile device 120. In some implementations, beacon 140 is a BLE beacon. Beacon 140 can transmit customized messages to the mobile device 120 based on the location of the mobile device 120.

Beacon 140 can output a wireless signal that can be detected by mobile device 120 when mobile device 120 is within a certain proximity of the beacon 140. Beacon 140 may be a device that periodically or continuously transmits a signal, such as a short-distance wireless (e.g., BLE), medium distance wireless (e.g., Wi-Fi), and/or other electro, magnetic, and/or electro-magnetic transmissions. Power on beacon 140 can be adjusted to communicate only within a desired range, which may depend on intended message ranges. Mobile device 120 is configured to detect the transmitted signals from beacon 140, such that when mobile device 120 is located within the transmission range of beacon 140, the signal may be detected.

The service provider server 180, in one embodiment, may be maintained by a transaction processing entity, which may provide processing for financial transactions and/or information transactions between the user 102, merchant server 130, and beacon 140. As such, the service provider server 180 includes a service application 182, which may be adapted to interact with the mobile device 120, merchant server 130, and/or beacon 140 over the network 160. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service provider server 180, in one embodiment, may be configured to maintain one or more user accounts and merchant accounts in an account database 186 each of which may include account information 188 associated with one or more individual users (e.g., user 102) and merchants. For example, account information 188 may include private financial information of user 102, such as one or more account numbers, passwords, credit card information, banking information, or other types of financial information, which may be used to facilitate financial transactions between user 102 and a merchant. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and user 102 may have credentials to authenticate or verify identity with the service provider server 180. User attributes may include personal information, banking information and/or funding sources. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

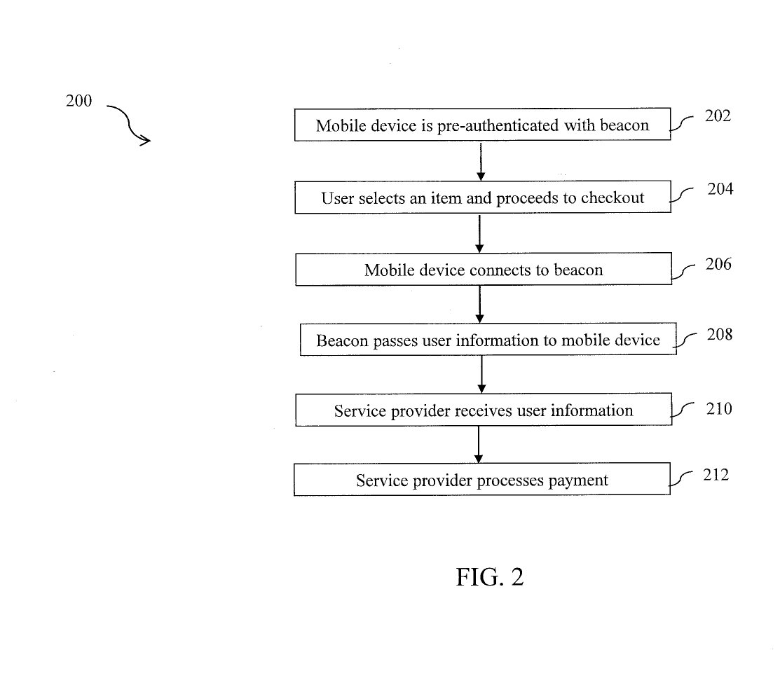

Referring now to FIG. 2, a flowchart 200 of a method for facilitating online checkout is illustrated according to an embodiment of the present disclosure. In various embodiments, the user 102 registers with a service provider, which runs a mobile application. Registration may include signing up for the service and agreeing to any terms required by the service provider, such as through a user device. In one embodiment, the user device is a mobile computing device, such as a smartphone, a PC, or a computing tablet. In other embodiments, registration may be done completely through the user device, partially through the user device, or without using the user device, such as through a phone call or in-person visit to a representative of the payment service provider.

The user may be requested to provider specific information for registration, such as, but not limited to, a name, address, phone number, email address, picture, a user name for the account, a password or PIN for the account, or other biometric identification such as a fingerprint. The type of information may depend on whether the user already has an account with the service provider. Requested information may be entered through the user device or other means, including voice or manual key entry. Once all the requested information is received and confirmed, the service provider may create an account for the user.

At step 202, mobile device 120 is pre-authenticated with the beacon 140. The mobile device 120 is associated with a known user with a known identity that is authorized to pay with an account associated with the service provider. Pre-authentication allows a list of possible devices to be known and addressable so that if a device is valid and authenticated, it can use the beacon 140 to make a payment using an account with the service provider. The user 102 may have previously configured the beacon 140 to recognize only certain user devices. For example, only devices associated with members of a household may be pre-authenticated. In various embodiments, the user 102 may set purchase limits for certain recognized devices. For example, the mobile device of a teenager may only be authorized to make purchases having a value of less than $100, while the mobile device of an adult may have no purchase limit.

The user 102 uses mobile device 120 to shop. For example, the user 102 may access a merchant site, seller site, marketplace site, or other site or mobile app that enables a user to shop and make a purchase. The user 102 then selects desired items for purchase. The purchase may be items, physical goods, digital goods, donations, services, etc. Note that items, as used herein, may include one or more of the different purchases listed above. The selected items may be placed in a cart, which the user 102 can review and edit if needed.

At step 204, the user 102 selects an item or items for purchase on the mobile device 120 and proceeds to checkout. For merchants configured to use the beacon service, a “Pay with Beacon” button may be integrated into the merchant checkout flow. The user 102 clicks on the button to indicate that he or she wants to use the beacon 140 for checkout.

At step 206, the mobile device 120 makes a connection with beacon 140. The beacon 140 senses user 102's presence by way of electronic communication with mobile device 120. The beacon 140 receives mobile device details (e.g., user identifier 126) from the mobile device 120 and identifies the mobile device 120 as a device that is pre-authenticated and authorized to use the beacon 140 to make payments.

The beacon 140 stores user information (e.g., user name, password, PIN, payment information, billing information, shipping address information, etc.) and outputs short-range signals that include this user information. The beacon 140 is placed in a secure environment, such as a home, private office, car, etc., so the risk of this sensitive information being transmitted to unauthorized users is diminished. In one example, the beacon 140 is placed in a car and used to pay a toll or parking fee.

In some embodiments, the user information is provided by the service provider. For example, the service provider may provide the beacon 140 with information that had been previously captured from user 102. Funding source information, billing information, and shipping information may be the last used information of user 102. The user 102, however, is allowed to change any of the user information stored on beacon 140.

In various embodiments, the beacon 140 may be placed in a geo-fenced location. A geo-fenced location has a virtual perimeter for a real-world geographic area that can be dynamically generated by defining a radius around a point location (e.g., a store) or a region by specifying a predefined set of boundaries (e.g., neighborhood boundaries). When a location-aware device (e.g., mobile device 120) enters or exits a geo-fenced location, the device can receive a message that contains information related to the location of the device.

At step 208, the beacon 140 passes the user information to the mobile device 120. The information is received by the mobile device 120 and is used to complete the information needed to checkout and pay for the purchase. For example, user login credentials, funding source information, and shipping address information are transmitted to the mobile device 120 and used to fill in the fields in a checkout page. The fields can include email address, name on credit card, credit card number, card number expiry date, card security code, telephone number, and street address. In various embodiments, the user 102 may be asked to provide permission for the beacon 140 to populate the checkout page, and the user 102 is able to select which details should be automatically provided. This user information, as well as details of the transaction are transmitted to the service provider server 180. Details of the transaction can include transaction amount, merchant associated with the purchase, item description, item prices, total price, shipping costs, tax, etc.

At step 210, the service provider server 180 receives the user information and details of the transaction. At step 212, the service provider server 180 processes payment of the purchase. The processing may include debiting the appropriate amount of funds from a user account and crediting the appropriate amount of funds to the merchant.

Advantageously, the user 102 checks out and completes the transaction by merely clicking a button with no further interaction with multiple screens. The user 102 is not required to enter a PIN, password, billing information, and/or shipping information. All the user 102 needs to do is click a button and the transaction is completed. Accordingly, the method 200 provides a method that is convenient and efficient for the user 102. The whole checkout process is streamlined, thereby providing a benefit both to the user 102 and the merchant.

In some embodiments, the merchant associated with the purchase may not be configured to use the beacon service. In these cases, the user 102 can select a bookmarklet previously established to run additional JavaScript commands on the page that can communicate with the beacon 140 to obtain user information. This user information can then be used to fill in the necessary fields automatically on the webpage. For desktop browsers like Google Chrome® or Mozilla Firefox®, a plugin can perform a similar function as an alternative to setting up a bookmarklet.

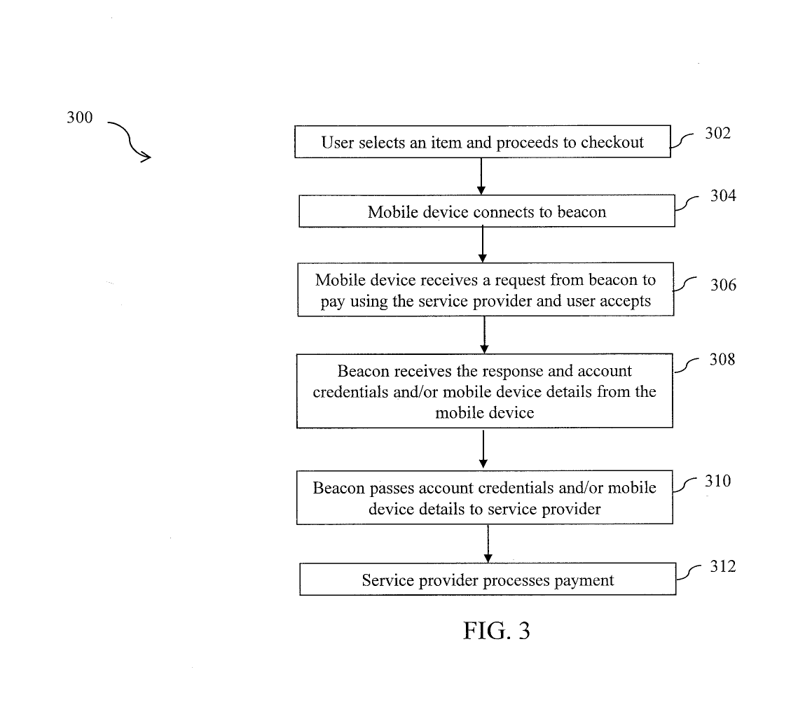

Referring now to FIG. 3, a flowchart 300 of another method for facilitating online checkout is illustrated according to an embodiment of the present disclosure. At step 302, the user 102 selects an item for purchase on a computing device and proceeds to checkout. The computing device, in some embodiments, is equipped with a beacon 140. If the user 102 is paying with a service provider, such as PayPal® Inc. of San Jose, the user 102 selects an appropriate button or link on the merchant page.

In various embodiments, a “Checkout with Beacon” or “Beacon Pay” button may be integrated into the merchant checkout flow, and the user 102 clicks on the button. This turns on or activates the beacon 140 of the computing device. Once the beacon 140 is turned on, the beacon 140 transmits short-range signals that include a request to pay using the service provider. For example, the signals can include a message such as “Do you want to pay with PayPal for this item?”

At step 304, the mobile device 120 makes a connection with beacon 140. The beacon 140 senses user 102's presence by way of electronic communication with mobile device 120.

At step 306, the mobile device 120 receives the request from the beacon 140, and the user 102 accepts the request. For example, the user 102 can swipe the screen of the user device 120 with his or her finger or click a “YES” button. Once the user 102 accepts, the mobile device 120 sends account credentials (e.g., user name, password, PIN, address, email address, phone number, answers to security questions, etc.) and/or other information, such as mobile device details, to the beacon 140.

At step 308, the beacon 140 receives the account credentials and/or the mobile device details (e.g., user identifier 126) from the mobile device 120, and at step 310, the beacon 140 passes this information to the service provider server 180. The user 102 can be authenticated by the service provider server 180 using the user identifier 126 and/or the account credentials. In any case, the user 102 is automatically logged in with the service provider. The user identifier 126 and/or the account credentials may be used by the service provider server 180 to associate the user 102 with a particular user account maintained by the service provider server 180.

Once logged in, the user 102 can complete the necessary fields for checkout (e.g., payment information, billing address, shipping address, etc.). In some embodiments, the service provider pre-populates the fields with information captured from the user 102 in previous transactions. For example, the service provider 102 can use the user identifier 126 to retrieve information previously provided by the user 102. Such information can include the last used funding source, billing address, and shipping address. To the extent that the user 102 wants to change any of the information, a drop down list or another type of user interface element may be made available to the user 102 so that the user 102 can easily select another option or enter another option.

At step 312, the service provider server 180 processes payment of the purchase. The processing may include debiting the appropriate amount of funds from a user account and crediting the appropriate amount of funds to the merchant.

The present disclosure describes systems and methods that streamline online checkout. In various embodiments, users are not required to enter or provide information that is typically requested during checkout. A user can complete a transaction without having to manually provide transaction related information. As a result, the number of steps required to be performed by the user to process a payment request are minimized. Note that while the above process focuses on communication using beacons through Bluetooth Low Energy, other ways of implementing various embodiments may also be suitable, such as, but not limited to LTE Direct.

In various embodiments, certain requirements must be met before information (e.g., account credentials, payment information, and shipping address information) is transmitted. Factors to be considered before transmitting information may include purchase amount, identity of merchant, category of merchant, time of day, day of week, number of devices detected, amount of interaction a user has with a financial account, location, and identity of user. For example, information may be communicated during certain times of the day, certain times of the week, only when less than a certain number of devices are detected (there may be combinations of devices associated with a user, with contacts of the user, with unknown devices, etc.). Restrictions can be based on location, such that certain information is communicated at a user's work location and other information is communicated at a user's home location (or relative's location or some other location known to the user). The time restrictions can also vary depending on the location (e.g., no communication if work location on weekend, etc.). For instance, if the purchase amount is $500, the merchant is a toy store, the location of the transaction is at home, the identity of the user is a child, and the time of day is at noon, the information may not be transmitted because the transaction is likely not authorized. On the other hand, if the purchase amount is $100, the merchant is an office supply store, the location of the transaction is an office, the identity of the user is an adult, the adult has a significant amount of interaction with the financial account, and the time of day is 10 AM, the information may be transmitted because it is likely that the transaction is authorized.

In some embodiments, if only some requirements are met (and not all), not all information may be communicated. For example, only less secure information (e.g., shipping address and billing address) may be communicated, while more sensitive information (e.g., credit card information, bank account information, and authentication information) is not. This still gives a user an advantage of not filling out all requested information and only a subset of the information to save time. For instance, if the user is at work on the weekend, the transaction amount is $200, and the merchant is a clothing store, the user may be required to manually input login information and payment information, but shipping and billing addresses may be provided. If the user is at home on a weekday, the time of day is 8 PM, the merchant is a home goods store, and the transaction amount is $100, login credentials may be provided, but the user may be required to manually input payment information.

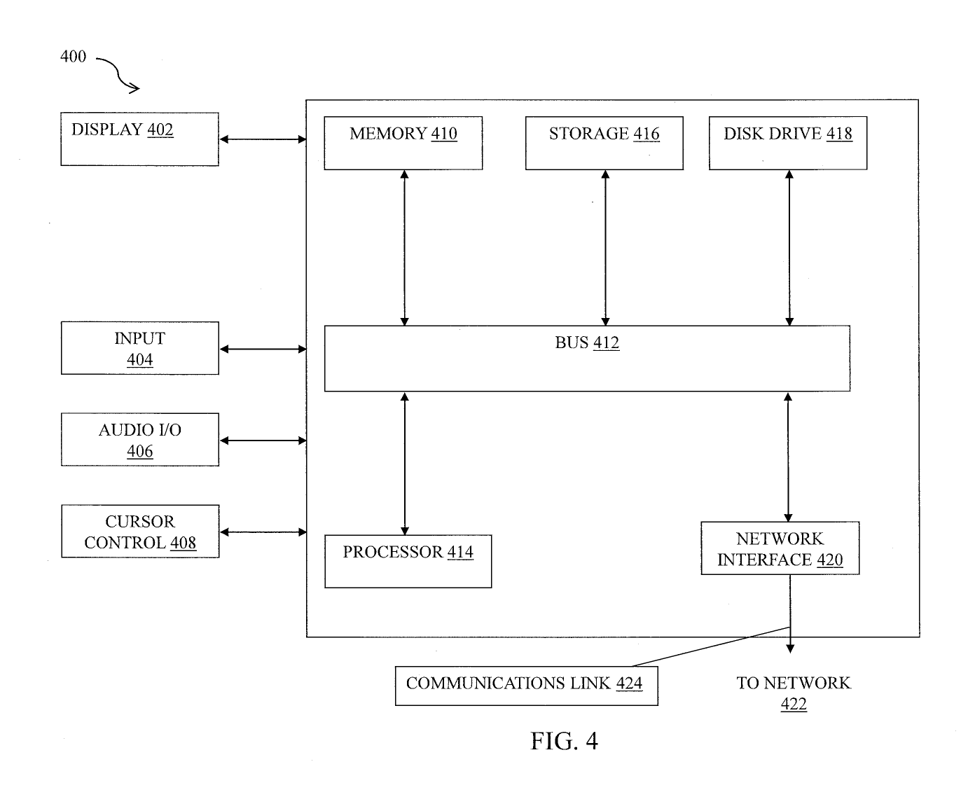

FIG. 4 is a block diagram of a computer system 400 suitable for implementing one or more embodiments of the present disclosure, including the mobile device 120, the merchant device or server 130, beacon 140, and the service provider server 180. In various implementations, the mobile device 120, merchant device or server 130, and beacon 140, and may comprise a mobile cellular phone, personal computer (PC), laptop, wearable computing device, etc. adapted for wireless communication, and the service provider server 180 may comprise a network computing device, such as a server. Thus, it should be appreciated that the devices 120, 130, 140, and 180 may be implemented as computer system 400 in a manner as follows.

Computer system 400 includes a bus 412 or other communication mechanism for communicating information data, signals, and information between various components of computer system 400. Components include an input/output (I/O) component 404 that processes a user (i.e., sender, recipient, service provider) action, such as selecting keys from a keypad/keyboard, selecting one or more buttons or links, etc., and sends a corresponding signal to bus 412. I/O component 404 may also include an output component, such as a display 402 and a cursor control 408 (such as a keyboard, keypad, mouse, etc.). An optional audio input/output component 406 may also be included to allow a user to use voice for inputting information by converting audio signals. Audio I/O component 406 may allow the user to hear audio. A transceiver or network interface 420 transmits and receives signals between computer system 400 and other devices, such as another user device, a merchant server, or a service provider server via network 422. In one embodiment, the transmission is wireless, although other transmission mediums and methods may also be suitable. A processor 414, which can be a micro-controller, digital signal processor (DSP), or other processing component, processes these various signals, such as for display on computer system 400 or transmission to other devices via a communication link 424. Processor 414 may also control transmission of information, such as cookies or IP addresses, to other devices.

Components of computer system 400 also include a system memory component 410 (e.g., RAM), a static storage component 416 (e.g., ROM), and/or a disk drive 418. Computer system 400 performs specific operations by processor 414 and other components by executing one or more sequences of instructions contained in system memory component 410. Logic may be encoded in a computer readable medium, which may refer to any medium that participates in providing instructions to processor 414 for execution. Such a medium may take many forms, including but not limited to, non-volatile media, volatile media, and transmission media. In various implementations, non-volatile media includes optical or magnetic disks, volatile media includes dynamic memory, such as system memory component 410, and transmission media includes coaxial cables, copper wire, and fiber optics, including wires that comprise bus 412. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 424 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A mobile device, comprising:
a non-transitory memory storing user account information; and
one or more hardware processors coupled to the non-transitory memory and configured to read instructions from the non-transitory memory to cause the mobile device to perform operations comprising:
providing, via a user interface provided by the mobile device, access to a merchant site, the access being through a network communication link;
in response to receiving, via the user interface, a request to execute a purchase of the one or more items from the merchant site using beacon-assisted checkout, sending mobile device identification details to a beacon device through a short-range communication link that is distinct from the network communication link, the mobile device being previously registered with the beacon device, the beacon device being distinct from the merchant site, and the mobile device identification details being usable to authenticate the mobile device to the beacon device to facilitate the beacon device to reply with user information; and
in response to receiving the user information from the beacon device, automatically providing the user information for use in executing the purchase from the merchant site.

2. The mobile device of claim 1, wherein the mobile device identification details are sent to the beacon device located in a secure environment.

3. The mobile device of claim 1, wherein the user information comprises one or more of user login credentials, funding source information, and shipping information.

4. The mobile device of claim 1, wherein the operations further comprise providing, via the user interface, a list of checkout details to be automatically populated by the user information.

5. The mobile device of claim 4, wherein the operations further comprise receiving, via the user interface, a selection of certain checkout details to be automatically populated.

6. The mobile device of claim 1, wherein at least one condition associated with an account of the mobile device must be met before the user information is received.

7. The mobile device of claim 6, wherein the at least one condition comprises one or more of purchase amount, identity of merchant, category of merchant, time of day, day of week, number of devices detected, amount of interaction a user has with a financial account, location, or identity of user.

8. The mobile device of claim 1, wherein the type of user information received depends on a location of the mobile device.

9. The mobile device of claim 8, wherein the user information comprises one or more of user name, password, personal identification number, funding sources, billing address, and shipping address.

10. The mobile device of claim 9, wherein the user information received comprises only billing address and shipping address.

11. A method for facilitating online checkout with a beacon, comprising:
providing, by a mobile device, access to a merchant site to a user;
receiving, by the mobile device from the user, a request to purchase one or more items from the merchant site using beacon-assisted checkout;
transmitting, by the mobile device to a beacon device, mobile device identification details, wherein the mobile device identification details are usable to identify the mobile device as a device authorized to use the beacon device to make purchases; and
in response to the mobile device being identified as an authorized device, receiving, by the mobile device from the beacon device, user information that automatically populates fields in a checkout page on the merchant site.

12. The method of claim 11, wherein the transmitting is to the beacon device located in a secure environment.

13. The method of claim 11, wherein the fields in the checkout page include one or more of email address, name on credit card, credit card number, card number expiry date, card security code, telephone number, and street address.

14. The method of claim 11, wherein at least one condition associated with an account of the mobile device must be met before the user information is received.

15. The method of claim 14, wherein the at least one condition comprises one or more of purchase amount, identity of merchant, category of merchant, time of day, day of week, number of devices detected, amount of interaction a user has with a financial account, location, or identity of user.

16. The method of claim 11, wherein the type of user information received depends on a location of the mobile device.

17. The method of claim 16, wherein the mobile device is located at a work location and the user information received comprises only billing address and shipping address.

18. A non-transitory machine-readable medium having stored thereon machine-readable instructions executable to cause a mobile device to perform operations comprising:
receiving, from a beacon device, a request to pay for a purchase made on a merchant site using a payment service provider;
receiving an indication that a user accepts the request; and
transmitting mobile device identification details and account credentials to the beacon device, wherein the user is authenticated using the mobile device identification details and the user is automatically logged in to a payment service provider site on a different user device using the account credentials.

19. The non-transitory machine-readable medium of claim 18, wherein the account credentials comprise one or more of a user name, password, personal identification number, address, email address, phone number, and answer to a security question.

20. The non-transitory machine-readable medium of claim 18, wherein the operations further comprise receiving payment information from the user.
